(19) United States
(12) Patent Application Publication
(10) Pub. No.: US 2005/0144806 A1
(43) Pub. Date: Jul. 7, 2005

(54) Dryer for a recording medium

(75) Inventor: Futoshi Yoshida, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: Fuji Photo Film Co., Ltd.

(21) Appl. No.: 11/019,305

(22) Filed: Dec. 23, 2004

(30) Foreign Application Priority Data
Jan. 7, 2004 (JP) 2004-002400

(51) Int. Cl. F26B 19/00; F26B 9/00

(52) U.S. Cl. 34/618; 34/638

(57) ABSTRACT

A circulation duct circulates dry air, which has been jetted to a photosensitive material, in a dryer. A temperature sensor is disposed near an entry of the circulation duct to detect a temperature of the circulation air. A controller obtains temperature information of the circulation air from the temperature sensor. On the basis of the temperature information, a heater is controlled to adjust a temperature of the dry air. When the temperature of the circulation air decreases, the temperature decline is simultaneously detected to raise the temperature of the dry air. Thus, the temperature of the dry air is fixedly kept, and dry processing of the photosensitive material becomes stable. Further, a drying speed is prevented from lowering.

### BACKGROUND OF THE INVENTION

1. Field of the Invention

The present invention relates to a dryer for drying a wet recording medium, which is carried in a drying chamber, by jetting dry air.

2. Description of the Related Art

In an automatic processor, for example in a printer processor used in a photofinishing laboratory, a photosensitive material of a photographic paper and so forth is severed in accordance with a print size so as to have a cut-sheet shape, and various kinds of print processing including exposure, back printing and so forth are executed. After the print processing, the photosensitive material is forwarded to a processor section to execute development processing. In the processor section, are sequentially performed color development, bleaching/fixing, washing, stabilization and so forth.

After executing the development processing, the photosensitive material is transported to a dryer comprising a blower and a heater. The blower sends dry air to a drying chamber via a blower duct. The heater is disposed at the blower duct to heat the dry air to be sent to the drying chamber by the blower. The dryer jets the dry air to dry the photosensitive material carried in the drying chamber. Meanwhile, the dry air jetted to the photosensitive material is circulated and returned to the blower via a circulation duct. In this kind of the dryer, a temperature sensor is disposed inside the blower duct to detect a temperature of the dry air. On the basis of temperature information obtained by the temperature sensor, the heater is controlled to adjust the temperature of the dry air (see Japanese Patent Laid-Open Publication No. 9-133998).

However, in the dryer described in the above Publication No. 9-133998, the temperature sensor for detecting the temperature of the dry air is disposed in the blower duct to detect the temperature of the dry air just heated by the heater, and the heater is controlled on the basis of the information concerning the obtained temperature. Thus, when the temperature of the circulation air decreases, the temperature decline of the dry air is not fed back to control the heater. Incidentally, the temperature of the circulation air means the temperature of the dry air which has been jetted to the photosensitive material while the photosensitive material is carried in the drying chamber. In such a case, there arises a problem in that a drying speed of the photosensitive material is lowered, since the temperature of the dry air decreases around the photosensitive material.

### SUMMARY OF THE INVENTION

In view of the foregoing, it is a primary object of the present invention to provide a dryer for a recording medium in which a drying speed of the photosensitive material is prevented from lowering.

In order to achieve the above and other objects, the dryer according to the present invention comprises a blower, a heater, a circulation duct, a temperature sensor and a controller. In the dryer, the wet recording medium is dried by jetting dry air while carried in a drying chamber. The blower sends the dry air into the drying chamber. The heater heats the dry air to be sent by the blower into the drying chamber. The circulation duct circulates the dry air, which has been jetted to the recording medium, to return it to the blower. The temperature sensor is disposed at the circulation duct to detect a temperature of the circulation air circulated by the circulation duct. The controller controls the heater on the basis of temperature information detected by the temperature sensor.

In a preferred embodiment, the dryer further comprises a blower duct for jetting the dry air sent from the blower, to the recording medium. The blower duct has a jet surface confronting the recording medium. The jet surface is formed with a plurality of nozzles through which the dry air is jetted. The blower and the heater are contained in the blower duct.

According to the dryer of the present invention, when the temperature of the circulation air decreases due to a change of a size of the recording medium and due to processing of a large amount of the recording medium, the temperature decline of the circulation air is detected and the temperature of the dry air is raised. Thus, the temperature of the dry air may be fixedly kept around the recording medium. It is possible to stably perform the dry processing of the recording medium despite the size and the processing amount of the recording media. Moreover, a drying speed may be prevented from lowering.

### BRIEF DESCRIPTION OF THE DRAWINGS

The above objects and advantages of the present invention will become apparent from the following detailed description of the preferred embodiments of the invention when read in conjunction with the accompanying drawings, in which:

FIG. 1 is a schematic illustration showing a structure of a printer processor;

FIG. 2 is a schematic illustration showing a structure of a dryer; and

FIG. 3 is a schematic illustration showing a structure of the dryer.

### DETAILED DESCRIPTION OF THE PREFERRED EMBODIMENT(S)

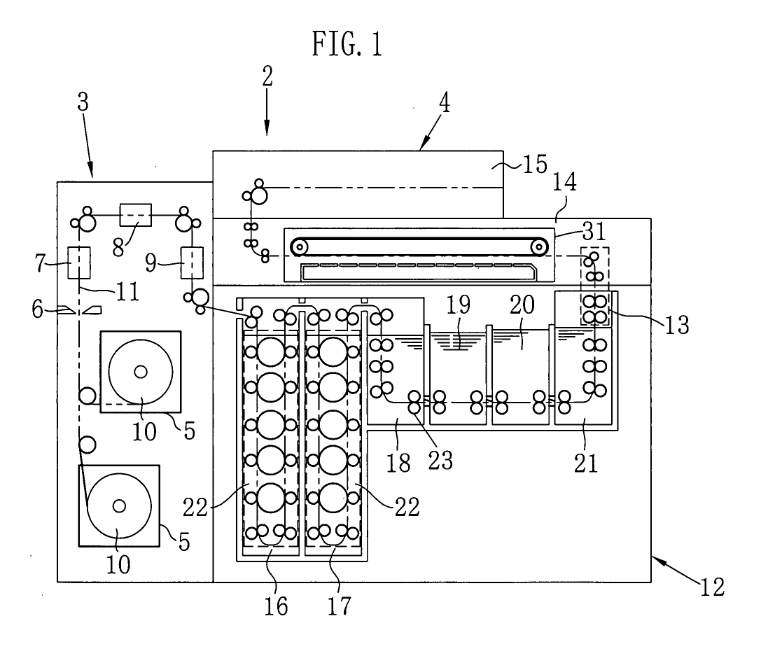

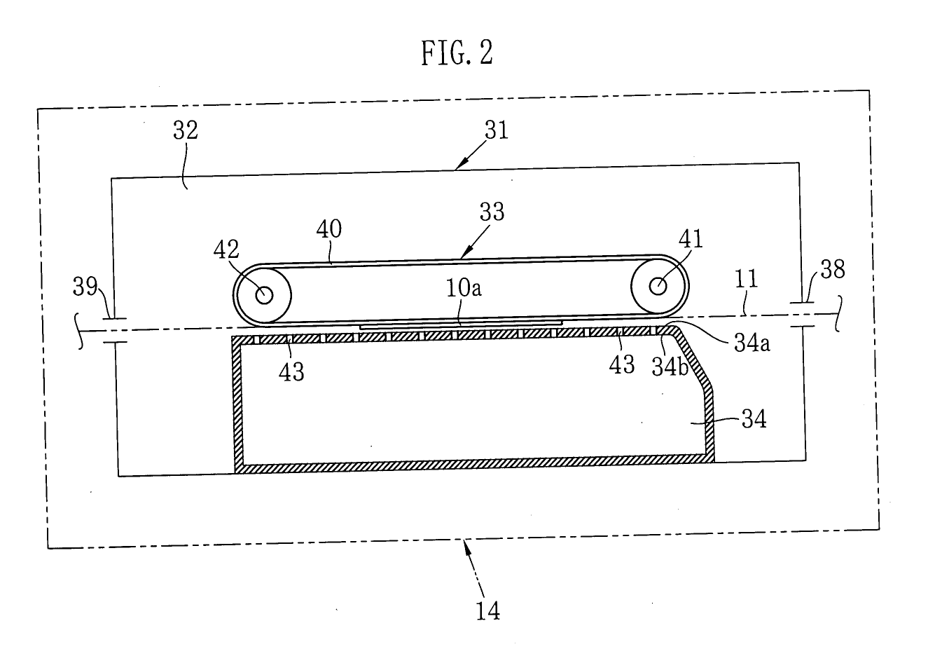

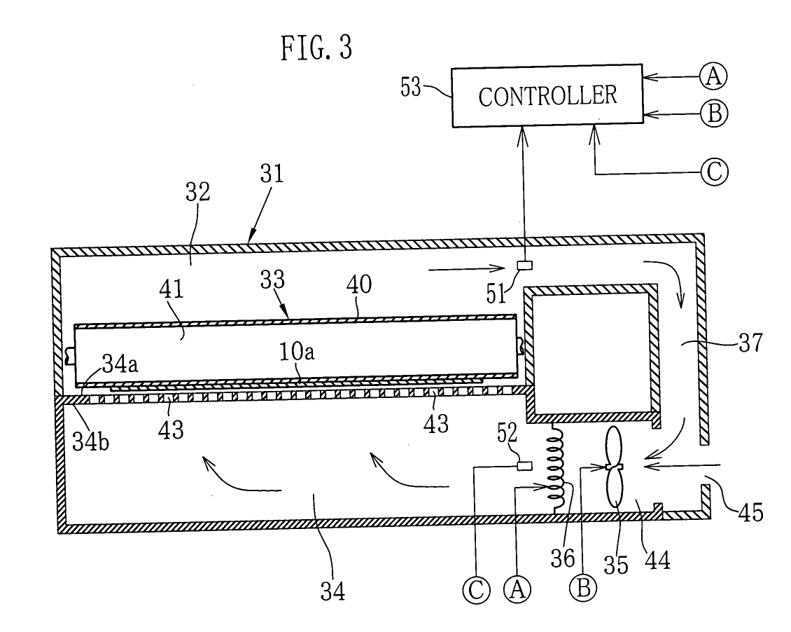

FIG. 1 is a schematic illustration showing an inner structure of a printer processor 2 using a dryer of the present invention. The printer processor 2 comprises a printer section 3 and a processor section 4. The printer section 3 includes magazines 5, a cutter 6, a back-printing unit 8 and a sorter 9. A photosensitive material 10 being as a strip-shaped recording medium is set in the magazine 5. The photosensitive material 10 is severed by the cutter 6 in accordance with a print size to produce the photosensitive material 10a of a cut-sheet shape (see FIGS. 2 and 3). The photosensitive material 10a is carried toward the exposure unit 8 along a passage shown by a chain double-dashed line in the drawing. On the way to the exposure unit 8, the back-printing unit 7 performs printing of a frame number, correction data and so forth. And then, in the exposure unit 8, exposure recording of an image is performed on a recording surface of the photosensitive material 10a on the basis of image data. After that, the exposed photosensitive material 10a is sorted by the sorter 9 into a single row or into plural rows (two rows, for example) in accordance with a print size and a print number. Successively, the exposed photosensitive material is forwarded to the processor section 4.

The processor section 4 includes a developing portion 12, a squeegee portion 13, a drying portion 14 and a sorter portion 15. The developing portion 12 includes a developing bath 16, a bleaching/fixing bath 17, and first through fourth washing baths 18 through 21, which are disposed in order from an upstream side in a carry direction of the photosensitive material 10a (namely, from the left side in the drawing). The developing bath 16, the bleaching/fixing bath 17, and the first to fourth baths 18 to 21 respectively contain developing solution, bleaching/fixing solution, and washing solution by a predetermined amount. A carry rack 22 comprising a plurality of carry rollers is disposed in each of the developing bath 16 and the bleaching/fixing bath 17. The carry rollers advance the photosensitive material 10a in the baths along a U-shaped route. Moreover, carry roller pairs 23 for advancing the photosensitive material 10a are disposed in the washing baths 18 to 21. The photosensitive material 10a is carried in the respective baths 16 to 21 by the carry rack 22 and the carry roller pairs 23. During this carry, processing is performed.

After performing the processing, moisture existing on a surface of the processed photosensitive material 10a is removed at the squeegee portion 13. And then, the photosensitive material 10a is forwarded to the drying portion 14 where dry air is jetted to the photosensitive material 10a to dry it. The dried photosensitive material 10a is forwarded to the sorter portion 15 where the photosensitive material 10a is sorted in accordance with an order.

The drying portion 14 is described below. The drying portion 14 includes a dryer 31 according to the present invention. As shown in FIGS. 2 and 3, the dryer 31 comprises a drying chamber 32 for drying the photosensitive material 10a, a conveyor 33 for carrying the photosensitive material 10a in the drying chamber 32, a blower duct 34 for introducing the dry air into the drying chamber 32, a blower 35 for sending the dry air into the drying chamber 32 via the blower duct 34, a heater 36 disposed in the blower duct 34 to heat the dry air sent by the blower 35, and a circulation duct 37 for circulating the dry air of the drying chamber 32 so as to guide the dry air to the blower 35.

The drying chamber 32 is provided with an entrance 38 through which the photosensitive material 10a is carried in from the squeegee portion 13, and an exit 39 through which the photosensitive material 10a is carried out toward the sorter portion 15. The entrance 38 is formed at an upstream side in the carry direction, and the exit 39 is formed at a downstream side.

The conveyor 33 is constituted of a conveyor belt 40 and belt rollers 41 and 42. The conveyor belt 40 is formed from a mesh belt of a net belt and so forth, and is laid between the belt rollers 41 and 42. The photosensitive material 10a is pressed against the conveyor belt 40 by levitation force of the dry air jetted from nozzles 43 described later. In this state, the photosensitive material 10a is carried. Hereby, the recording surface of the photosensitive material 10a is separated from a surface 34a of the blower duct 34 (hereinafter called as jet surface) confronting the photosensitive material 10a. Since the recording surface of the photosensitive material 10a is carried in this state, the recording surface is prevented from being damaged due to contact of the photosensitive material 10a and the jet surface 34a.

The jet surface 34a of the blower duct 34 is provided with the circular nozzles 43 formed in a width direction of the photosensitive material 10a. The nozzles 43 are arranged at predetermined intervals in the carry direction. The dry air is jetted from the nozzle 43 toward the recording surface of the photosensitive material 10a. Incidentally, the shape of the nozzle is not limited to the circular shape, but may be a slit shape and an ellipse shape. Further, a number and the arrangement interval of the nozzles may be properly changed in accordance with various conditions of a width and so forth of the photosensitive material 10a.

As shown in FIG. 3, in the blower duct 34, is formed a dry-air supply passage 44 for sending the dry air into the drying chamber 32. The inside of the dry-air supply passage 44 is provided with the blower (cross flow fan) 35 and the heater 36 disposed in front of the blower 35. Meanwhile, circulation air flows from the circulation duct 37, and ambient air flows from an ambient-air inlet 45 formed at the circulation duct 37. The circulation air and the ambient air are sent by the blower 35 toward the jet surface 34a as the dry air. At this time, the dry air is heated up to a predetermined temperature by the heater 36 disposed in front of the blower 35.

The dry air sent from the dry-air supply passage 44 is jetted toward the photosensitive material 10a via the jet surface 34a. Thus, the photosensitive material 10a is pressed against the conveyor belt 40 and is dried while carried by the conveyor belt 40. The dry air jetted to the photosensitive material 10a circulates in the drying chamber 32 through the circulation duct 37 and the blower duct 34.

In the meantime, a temperature sensor 51 for detecting a temperature of the circulation air is disposed near an entry of the circulation duct 37. The temperature sensor 51 is constituted of a thermistor, a thermocouple and so forth. The blower 35, the heater 36 and the temperature sensor 51 are connected to a controller 53 controlling the dryer 31. The controller 53 controls the blower 35 and the heater 36 on the basis of various conditions concerning a type of the photosensitive material 10a, a carry speed thereof, outer environment (humidity, for example), etc. so as to make a temperature of the dry air optimum. In addition, the controller 53 obtains temperature information of the circulation air from the temperature sensor 51. On the basis of the temperature information, the controller 53 controls the heater 36 to adjust the temperature of the dry air.

Another temperature sensor 52 for detecting the temperature of the dry air is disposed near a vent of the dry-air supply passage 44. In other words, the temperature sensor 52 is disposed in front of the heater 36. The temperature sensor 52 is connected to the controller 53, which obtains temperature information of the dry air just after the dry air has been heated by the heater 36. The heater 36 is controlled on the basis of this temperature information to secure safety by regulating the maximum temperature of the dry air.

Next, an operation of the dryer 31 having the above structure is described below. Upon transporting the photosensitive material 10a from the squeegee portion 13 to the drying portion 14, the controller 53 controls the conveyor 33 to carry the photosensitive material 10a, which has entered from the entrance 38, toward the exit 39. At the same time, the controller 53 controls the blower 35 and the heater 36 on the basis of the above-mentioned conditions so as to make the temperature of the dry air optimum. In virtue of this, the circulation air from the circulation duct 37 and the ambient air from the inlet 45 become the dry air heated up to the predetermined temperature. And then, the dry air is sent from the dry-air supply passage 44 toward the jet surface 34a.

The dry air sent from the dry-air supply passage 44 is jetted into the drying chamber 32 through the jet surface 34a toward the photosensitive material 10a carried in the drying chamber 32. The dry air having been jetted to the photosensitive material 10a is introduced again, by the circulation duct 37, into the dry-air supply passage 44 as the circulation air. The introduced circulation air is sent as the dry air toward the jet surface 34a through the dry-air supply passage 44 together with the ambient air introduced from the inlet 45.

The temperature sensor 51 detects the temperature information of the circulation air to output it to the controller 53. After obtaining the temperature information of the circulation air, the controller 53 controls the heater 36 to raise the temperature of the dry air when the temperature thereof decreases. By the way, the dried photosensitive material 10a is discharged from the exit 39 to the outside of the dryer 31.

In the above description, the controller 53 controls the heater 36 to raise the temperature of the dry air when the temperature thereof decreases. However, the temperature of the dry air may be raised only when the photosensitive material 10a is carried in the drying chamber 32. In another way, the temperature of the dry air may be set so as to be lower than a usual temperature when the photosensitive material is not carried in the drying chamber 32, and the temperature of the dry air may be raised when the photosensitive material just enters the drying chamber 32.

In this way, the temperature sensor detects the temperature of the dry air, namely the temperature of the circulation air, after the dry air has been jetted to the photosensitive material 10a. When the temperature of the circulation air decreases due to a change of a size of the photosensitive material and due to processing of a large amount of the photosensitive material, the controller 53 obtains the temperature information from the temperature sensor 51 to control the heater 36 on the basis of this temperature information. Thus, it is possible to stably perform the dry processing despite the size and the processing amount of the photosensitive material. Further, drying performance of the dryer is improved so that a drying speed of the photosensitive material is prevented from lowering.

In the above embodiment, the sole temperature sensor for detecting the temperature of the circulation air is disposed near the entry of the circulation duct. However, this is not exclusive. A plurality of the temperature sensors may be disposed in the circulation duct. In this case, the controller obtains the temperature information from the plural temperature sensors to calculate a mean temperature. On the basis of the mean temperature, the heater is controlled to adjust the temperature of the dry air.

Incidentally, besides the printer processor described in the above embodiment, the present invention is applicable to a dryer to be used for an ink-jet printer in which an ink is jetted from an ink-jet head to form an image on a recording medium.

Although the present invention has been fully described by way of the preferred embodiments thereof with reference to the accompanying drawings, various changes and modifications will be apparent to those having skill in this field. Therefore, unless otherwise these changes and modifications depart from the scope of the present invention, they should be construed as included therein.

1. A dryer for drying a wet recording medium, which is carried in a drying chamber, by jetting dry air, said dryer comprising:
a blower for sending said dry air into said drying chamber;
a heater for heating said dry air to be sent into said drying chamber by said blower;
a circulation duct for circulating said dry air, which has been jetted to said recording material, to return said dry air to said blower;
a first temperature sensor disposed at said circulation duct to detect a temperature of circulation air circulated by said circulation duct; and
a controller for controlling said heater on the basis of temperature information detected by said first temperature sensor.

2. A dryer according to claim 1, wherein said recoding medium is a photosensitive material having passed through a processing solution.

3. A dryer according to claim 1, further comprising:
a blower duct for jetting said dry air sent from said blower, to said recording medium, said blower duct being disposed at a position confronting said recording medium.

4. A dryer according to claim 3, wherein said blower duct has a jet surface confronting said recording medium, and said jet surface is formed with a plurality of nozzles for jetting said dry air.

5. A dryer according to claim 4, wherein said blower and said heater are contained in said blower duct.

6. A dryer according to claim 5, wherein said first temperature sensor is disposed near an entry of said circulation duct.

7. A dryer according to claim 6, further including:
a second temperature sensor for measuring a temperature of said dry air just having passed through said heater, in order to regulate the maximum temperature of the dry air heated by said heater.

8. A dryer according to claim 4, further comprising:
a conveyor disposed so as to confront said jet surface of said blower duct to carry said recording medium in said drying chamber, said recording medium being pressed against said conveyor by said dry air.

9. A dryer according to claim 8, wherein said conveyor is an endless belt laid between two rollers.

10. A dryer according to claim 9, wherein said endless belt is formed from a mesh belt, and said dry air having passed through said endless belt flows into said circulation duct.

11. A dryer according to claim 10, wherein said dry air sent from said blower includes said circulation air flowing from said circulation duct and ambient air flowing from an ambient-air inlet formed at said circulation duct.
